(19) United States
(12) Patent Application Publication
(10) Pub. No.: US 2022/0410499 A1
(43) Pub. Date: Dec. 29, 2022

(54) SYSTEMS AND METHODS FOR MATING COMPONENTS

(71) Applicant: Great Lakes IP Holdings LLC, West Bloomfield, MI (US)

(72) Inventor: Michael Kay, West Bloomfield, MI (US)

(73) Assignee: Great Lakes IP Holdings LLC, West Bloomfield, MI (US)

(21) Appl. No.: 17/356,225

(22) Filed: Jun. 23, 2021

(51) Int. Cl. B29C 65/48; B29C 65/00; C09J 7/38; C09J 7/20

(52) U.S. Cl. CPC B29C 65/48; B29C 66/024; B29C 66/729; C09J 7/38; C09J 7/20; B64C 1/069

(57) ABSTRACT

Systems and methods for mating component parts are described. In some embodiments, a system for mating components may include a first component, a second component, a first adhesive, and a second adhesive. The first adhesive may be configured to set in less than 5 minutes after the first component and the second component are placed in a mating position, and the second adhesive may require greater than 5 minutes to set. The first adhesive, after setting, may have sufficient strength to maintain the first component and the second component in the mating position while the second adhesive sets.

### FIELD OF THE DISCLOSURE

This disclosure relates to mating systems and methods. Specifically, this disclosure relates to systems and methods for the mating of two or more components, for example, in aircraft assembly.

### BACKGROUND

Assembling aircraft and other devices is time and labor intensive. Assembly cost is becoming an increasingly large fraction of total cost as many aircraft, such as small and mid-sized aircraft such as drones, need to be produced in large quantities. Manual skilled labor and the cost of logistics can bring assembly cost into the millions of dollars per unit. Added to the amortized cost in design, engineering, assembly systems equipment, product development, testing, and certification, the breakeven point for aircraft manufacturing can be hundreds of units and years of production. Traditional manufacturing methods, including drilling holes and riveting components together, do not meet the growing need for cost-effective, large-scale production.

Accordingly, there is a need for methods for effectively mating component parts in a way that reduces assembly costs and time without sacrificing a finished product's structural integrity. Further, there is a need for systems that effectively mate component parts using these methods.

### SUMMARY

The following description presents a simplified summary in order to provide a basic understanding of some aspects described herein. This summary is not an extensive overview of the claimed subject matter. It is intended to neither identify key or critical elements of the claimed subject matter nor delineate the scope thereof.

In some embodiments, a system for mating components may be provided. The system may include a first component, a second component, a first adhesive; and a second adhesive, the second adhesive being different than the first adhesive. The first adhesive may be configured to set in less than 5 minutes after the first component and the second component are placed in the mating position, and the second adhesive may require greater than 5 minutes to set. The first adhesive, after setting, may have sufficient strength to maintain the first component and the second component in the mating position while the second adhesive sets. In some embodiments, the first component may include a first plurality of holes. In some embodiments, the second component may include a second plurality of holes, and the first plurality of holes and the second plurality of holes may be arranged such that, when the first component and the second component are placed in a mating position relative to one-another, the first plurality of holes may be aligned with the second plurality of holes. In some embodiments, the first adhesive may be positioned in the first plurality of holes. In some embodiments, the first adhesive may include a first compound, a second compound, and the first compound and the second compound are configured to activate upon contact and thereby create the first adhesive. The first compound may be positioned in the first plurality of holes and the second compound may be positioned in the second plurality of holes.

The first component and the second component may be selected from a group consisting of wing stringers, wing ribs, or panels. In some embodiments, the first component may be composed of carbon fiber. In some embodiments, the system may include an end effector that can place the first place the first component and the second component in a mating position relative to one-another. The first adhesive may be configured to set in less than 30 seconds after the first component and the second component are placed in the mating position. In some embodiments, a surface on which the first adhesive is applied may be roughened by laser etching.

In some embodiments, a method for mating components may use a system including a first component, a second component, a first adhesive applied to at least one of the first component and the second component, a second adhesive applied to at least one of the first component and the second component, and an end effector. In some embodiments, the method may include coupling the end effector to the first component, positioning, using the end effector, the first component in a mating position relative to the second component, allowing the first adhesive to set, the first adhesive setting in less than 5 minutes after the first component and the second component are placed in the mating position, decoupling the end effector from the first component after the first adhesive has set, and allowing the second adhesive to set. In some embodiments, the second adhesive may require greater than 5 minutes to set. The first adhesive may maintain the first component and the second component in the mating position while the second adhesive sets. In some embodiments, the first component may include a first plurality of holes. In some embodiments, the second component may include a second plurality of holes, and the first plurality of holes and the second plurality of holes may be arranged such that, when the first component and the second component are placed in a mating position relative to one-another, the first plurality of holes are aligned with the second plurality of holes. In some embodiments, the first adhesive may be positioned in the first plurality of holes. In some embodiments, the first adhesive may include a first compound and a second compound. The first compound and the second compound may be configured to activate upon contact and thereby create the second adhesive. The first compound may be positioned in the first plurality of holes and the second compound may be positioned in the second plurality of holes. The first component and the second component be selected from a group consisting of wing stringers, wing ribs, or panels. In some embodiments, the first component may be composed of carbon fiber. The first adhesive may be configured to set in less than 30 seconds after the first component and the second component are placed in the mating position. In some embodiments, a surface on which the first adhesive is applied may be roughened by laser etching.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 shows a first component mated to a second component.

FIG. 2 shows an exemplary system for mating components.

FIG. 3A shows exemplary wing stringer components.

FIG. 3B shows exemplary wing rib components.

FIG. 3C shows exemplary panel components.

FIG. 4 shows an exemplary method for mating components.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

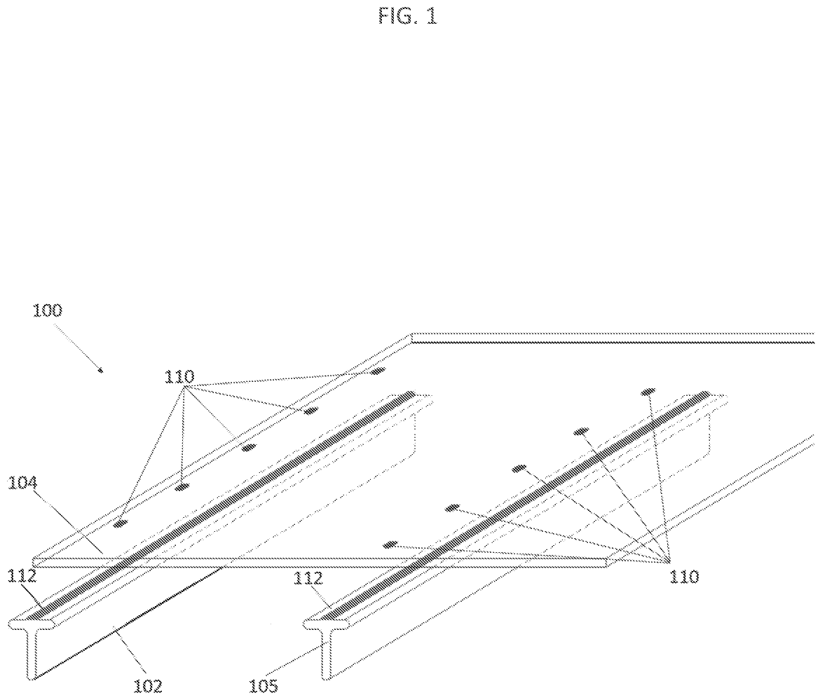

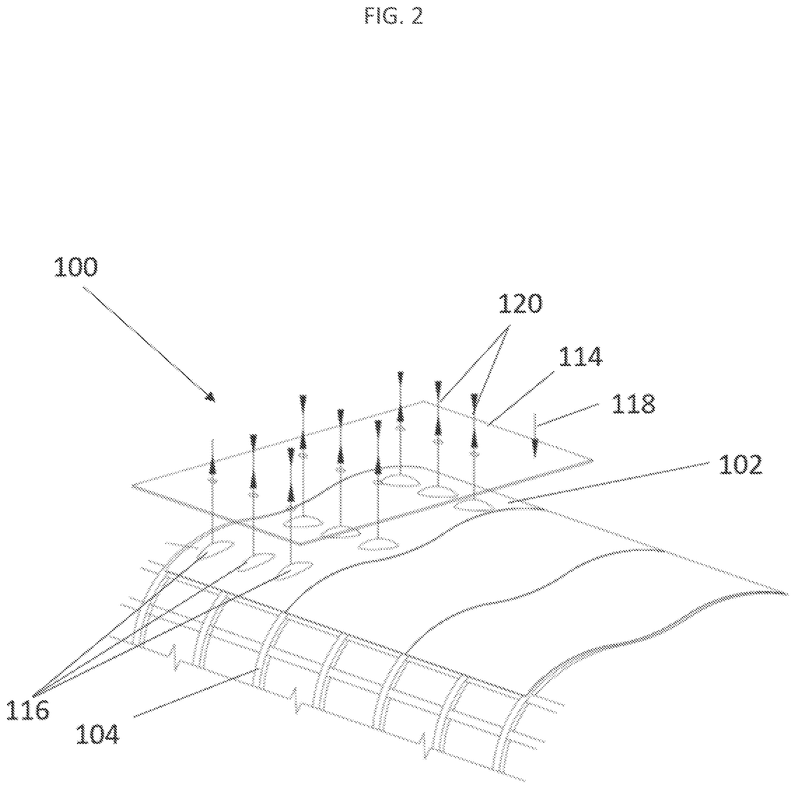

FIG. 1 shows an exemplary system 100 for mating components. In some embodiments, the system 100 may be configured to cost-effectively mate components without the use of rivets, bolts, or other hardware fasteners. As shown in FIG. 1, the system may include a first component 102 and a second component 104, to which the first component 102 is or will be mated. The system may further include a first adhesive 110 and a second adhesive 112. In some embodiments, the system may include a third component 105, which may also be configured to be mated to the second component 104. In some embodiments, the system may further include an end effector 114, as shown in FIG. 2.

In some embodiments, the first adhesive 110 may be configured to cure relatively quickly and hold the components 102, 104 in a mating position while the second adhesive 112 cures. The second adhesive 112 may be a structural adhesive with sufficient strength to hold the components in place during use. For example, in the case of an aircraft, the second adhesive 112 may have sufficient strength to hold the components in place during flight.

In use, the first and second adhesives 110, 112 may be applied to surfaces of the first and second components 102, 104. Each adhesive may be applied to each component, one adhesive may be applied to each component, or both adhesives may be applied on one component. The components may be positioned in a desired position relative to one-another such that the surfaces on which the adhesives 110, 112 are applied are in contact with the opposed component. The components may be held in the desired position (e.g., by an end effector, which may also apply forces to shape one or both components) while the first adhesive 110 cures. The components may then be released from externally applied forces, such that the first adhesive 110 holds the components in the desired position while the second adhesive 112 cures.

The first adhesive 110 may be relatively fast-curing, which may minimize the time that the components need to be held in place using an external force. For example, the first adhesive 110 may cure in less than 15 minutes, less than 10 minutes, less than 5 minutes, less than 2 minutes, less than 90 seconds, less than 60 seconds, less than 45 seconds, less than 30 seconds, less than 20 seconds, less than 15 seconds, less than 10 seconds, or less than 5 seconds. The first adhesive may also have sufficient strength to hold the components in the mating position (which may be a position in which one or both of the components has been elastically deformed under an external force). In some embodiments, the first adhesive may be sufficiently viscous so that it may be readily applied to a surface of the components and remain in place while the components are adjoined to one-another. For example, the first adhesive may have a viscosity greater than 500 cps, greater than 1,000 cps, greater than 2,000 cps, greater than 3,000 cps, greater than 4,000 cps, or greater than 5,000 cps. In some embodiments, the first adhesive may have a viscosity between 4,000-7,000 cps.

In some embodiments, the first adhesive may be a combination of an acrylic adhesive with an accelerant. For example, the first adhesive may be an acrylic adhesive that cures rapidly when exposed to an activator and/or a source of heat. Exemplary compounds sold by Loctite under the product numbers AA 331 (acrylic adhesive) and 7387 (accelerant) may be used. In some embodiments, the solvent for compound 7387 may be modified to increase the viscosity of the accelerant.

In some embodiments, the first adhesive may be a hot melt adhesive. Such adhesives may be applied using a heated dispenser having a temperature, measured at the tip of the dispenser, between 300-500° F. In some embodiments, the temperature may be between 350-420° F. Once applied to one of the components, the adhesive may begin cooling and may cure relatively quickly. For example, the adhesive may cure in less than 60 seconds after application, less than 40 seconds, less than 30 seconds, less than 20 seconds, less than 15 seconds, less than 10 seconds, or less than 5 seconds. Advantageously, the use of a hot melt adhesive may allow the first adhesive to be applied to only one of the two components, whereas using an adhesive with an accelerant may require applying one of the compounds for the adhesive to each of the two components such that the compounds interact and begin curing when the components are placed in contact with one-another. In some embodiments where the first adhesive is applied to only one of the components, it may be advantageous to apply the first adhesive to one of the two components to be mated, and to apply the second adhesive to the other component. This may advantageously reduce the risk that the adhesives contact and interfere with one-another before the components are mated. In some embodiments, the first adhesive may be a polymeric compound that becomes fluid when heated and then quickly cures when cooled. Exemplary compounds that may be used for the first adhesive include SuperTac 11-1, 3M 3764, and 3M 3748.

The second adhesive 112 may be selected from a variety of compounds. The second adhesive may be selected to bond with the material from which the components are made (e.g., carbon fiber) and to have sufficient strength, when cured, to securely maintain the components in a bonded state under use conditions (e.g., during flight). In some embodiments, the second adhesive may cure at or near room temperature. In some embodiments, the second adhesive may be a two-part compound. By way of example, the second adhesive 112 may be Loctite EA 9360 AERO, a two-component toughened paste adhesive with high peel strength, high tensile lap shear strength, and high static stress durability.

The first and second components 102, 104 may be composed of a range of materials including, for example, carbon fiber. Other materials may also be used. In some embodiments, the surfaces of the components 102, 104 may be roughened to improve the extent to which they bind and engage adhesives. For example, the surfaces may be laser etched. In some embodiments, one or both of the surfaces to be mated may have a surface grit of less than or equal to 500, a surface grit of less than or equal to 200, or a surface grit of less than or equal to 100, as measured in accordance with the Society for Protective Coating (SSPC) standard. In some embodiments, the surface grit may be between 100 and 200. For example, the surface grit may be between 150 and 170. In some embodiments, one or both of the surfaces may have a roughness measurement between 27 and 32 Ra pin. In some embodiments, the surfaces of the components may be locally laser etched, such that only the portions of the components which are intended to be mated are roughened, leaving other portions of the components smooth. This may simultaneously improve the bonding of the components while maintaining their aerodynamic characteristics.

FIG. 2 shows an example of a first component 102 being mated to a second component 104. In the exemplary embodiment shown in FIG. 2, the first component is a panel 102, and the second component is an aircraft frame 104. As shown in FIG. 2, an end effector 114 may engage, position, and shape the first component 102. For example, the end effector 114 may include a plurality of vacuum cups 116 which may be configured to engage and apply force to the first component 102 at a plurality of points. The vacuum cups may be controlled by servo motors or other actuators, as shown by vectors 118, and may apply force to the first component to correct any deviation from its intended shape prior to placement. The end effector 114 may be a robot or gantry.

The end effector 114 may position the first component 102 into a mating position with the second component 104. In some embodiments, the end effector 114 may be programmed to position the first component 102 such that it contacts the second component 104, and then, before the first adhesive cures, to slide the first component 102 while it is in contact with the second component until the first component contacts an adjacent component which has previously been mated to the second component 104. Sliding the components in this manner may substantially reduce or eliminate gaps between adjacent components, which may improve the aerodynamic properties of the resulting aircraft, relative to a conventional aircraft with mechanical fasteners, in which this type of sliding is not possible. Once the first component 102 is in its final mating position, the end effector may hold the first component 102 in place while the first adhesive cures. The end effector may then release the first component 102, allowing it to be held in place by the first adhesive while a stronger, structural adhesive cures.

As shown in FIG. 2, the end effector 114 may have nine servo controlled actuators 120, but it will be understood that the end effector 114 may have more actuators 120. The actuators 120 may adjust to the profile of the components 102, 104.

In some embodiments, if the components 102, 104 deviate from their intended shape (e.g., due to manufacturing inconsistences, application of heat, or other deformations), the end effector 114 may correct any anomalies of the first and second components 102, 104 before the components 102, 104 are brought together and held in place for mating.

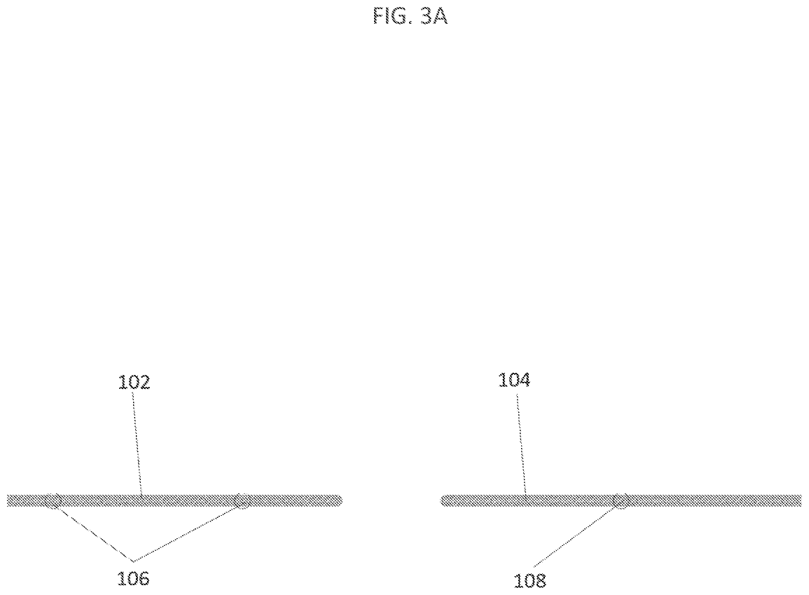

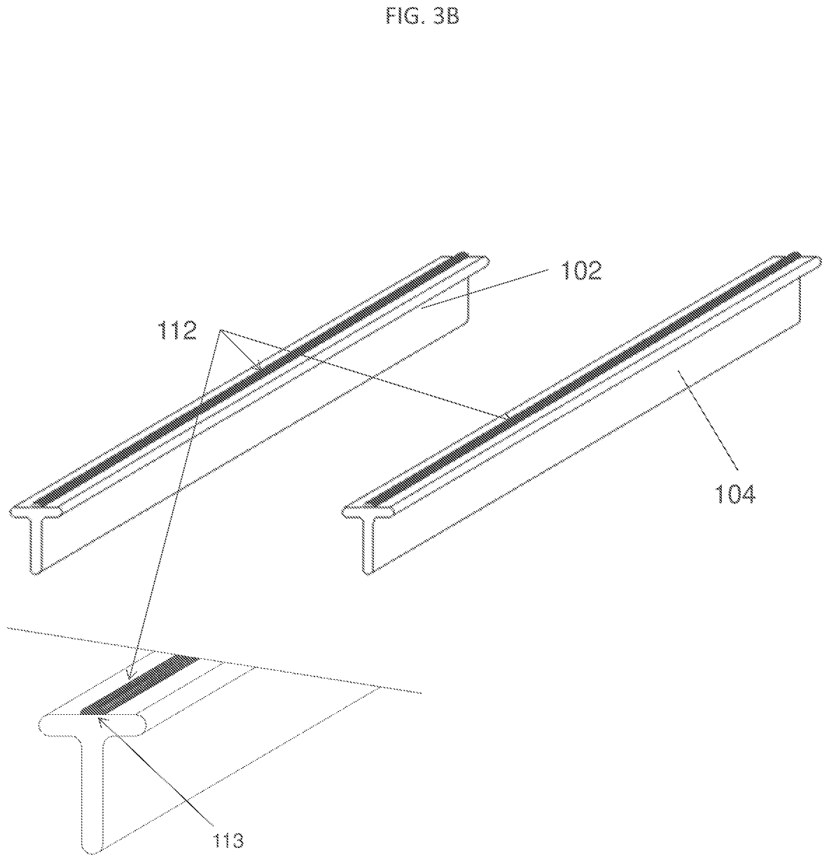

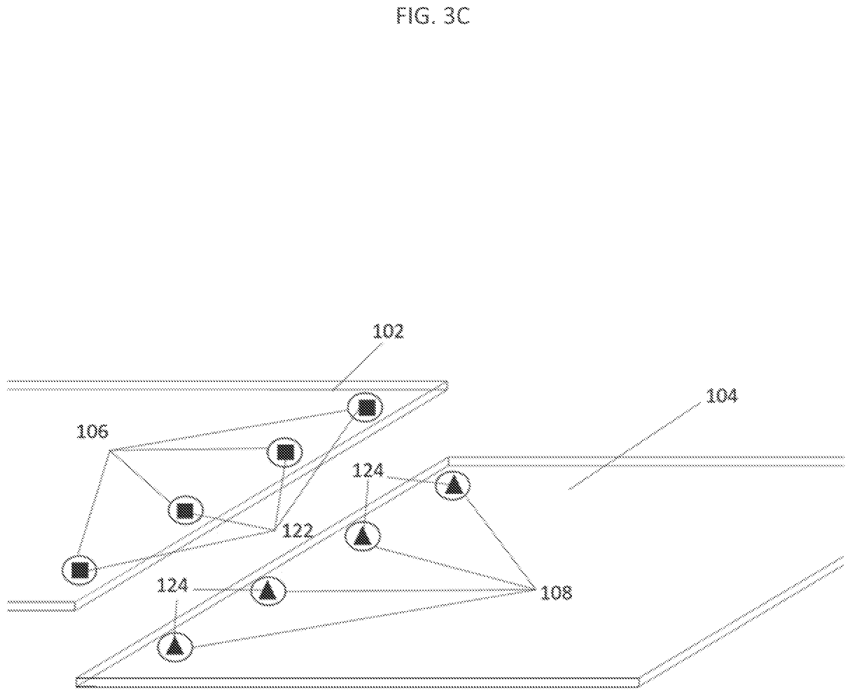

FIGS. 3A-3C show a variety of parts that may be used for the first and the second components 102, 104. For example, the first and second components 102, 104 may be wing stringers as shown in FIG. 3A, wing ribs as shown in FIG. 3B, or panels as shown in FIG. 3C. It will be understood that in some embodiments the first and second components 102, 104 may be the same part (e.g., they may both be wing ribs). It will additionally be understood that in some embodiments, the first and second components 102, 104 may be different parts (e.g., one may be a wing rib and one may be a panel). It will be further still understood that the first and second component 102, 104 are not limited to wing stringers, wing ribs, or panels. As shown in FIG. 3B, one or both of the first and second adhesives may be deposited in a bead or line having a radius 113. In some embodiments, the radius may vary over the length or geometry of a component. For example, the radius of the first adhesive may be greater in areas requiring additional strength to maintain an elastically deformed state or to resist slippage while other components are added. The radius of the second adhesive may be greater in areas requiring grater structural strength during operation.

In some embodiments, one or both of the first and second components 102, 104 may include one or more holes 106, 108 (as shown in FIG. 3C). In some embodiments, the surfaces of the components 102, 104 may be prepared by drilling shallow holes, which may enhance the lateral single axis (shear) strength. For example, this may increase the lateral single axis shear strength of the component by as much as 50%. In some embodiments, the holes 106, 108 may be disposed along the first component 102 and the second component 104, respectively, such that the holes 106, 108 are evenly spaced (i.e. there is equal distance between each hole in the plurality of holes 106, 108). In other embodiments, the holes 106, 108 may be spaced irregularly.

In some embodiments, the holes 106 of the first component 102 may be positioned such that they align with the holes 108 of the second component 104 when the first component and the second component are arranged in an intended mating position relative to one-another. The size of the holes 106, 108 may be tailored to the needs of the product being assembled. For example, the holes 106, 108 may have different circumferences and depths depending on the material of the components 102, 104 and the design goals of the finished product. The depth of the holes 106, 108 may be limited to meet the need for structural integrity of the components 102, 104.

In some embodiments, such as that shown in FIG. 3, the first adhesive 110 may be composed of two compounds 122, 124. The first compound 122 (e.g., an adhesive) may be placed on the first component 106, and the second compound 124 (e.g., an activator) may be placed on the second component 108. The compounds 122, 124 may be positioned such that when the components 106, 108 are placed in a mating position relative to one another, the compounds 122, 124 contact one-another and interact. In this manner, the first adhesive 110 may resist curing until the first component contacts the second component, and then upon reaching the desired mating position, the first adhesive 110 may rapidly cure, e.g., in a span of seconds.

In some embodiments, adhesives or adhesive compounds may be positioned within holes on the components. By way of example, in FIG. 3C, the first compound 122 is disposed in the first plurality of holes 106 and the second compound 124 is disposed in the second plurality of holes 108. In some embodiments, the first adhesive 110 is created when the first compound 122 comes into contact with the second compound 124. In other embodiments, the adhesives or adhesive compounds may not be positioned within holes, or may they may be used on components that lack holes.

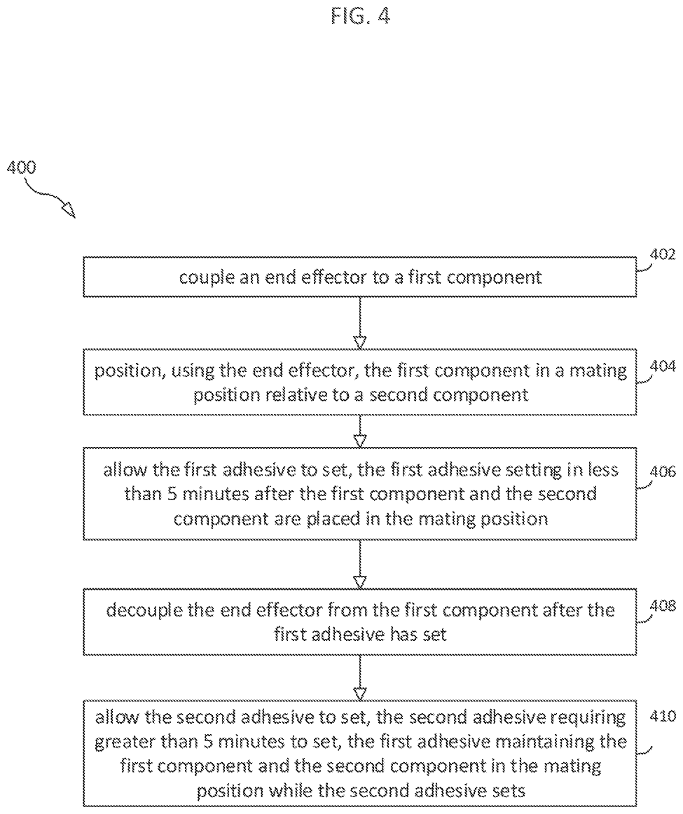

FIG. 4 shows an exemplary method 400 for mating components. In step 402, an end effector may be coupled to a first component. For example, an end effector such as that shown in FIG. 2 may be attached to the first component using vacuum cups, or any other suitable engagement structures. The end effector may apply a controlled force to the first component.

In step 404, the end effector may be used to position the first component in a mating position relative to a second component. In some embodiments, a first adhesive may be applied to at least one of the first component and the second component, and a second adhesive may also be applied to at least one of the first component and the second component. In some embodiments, the first adhesive may be a relatively fast-curing adhesive, and the second adhesive may be a structural adhesive with greater strength than the first adhesive. In some embodiments, the end effector may place the first component in contact with the second component in an initial position that approximates the intended mating position. For example, the initial placement may be within 1 inch, 0.5 inches, 0.025 inches, 0.1 inches, 0.05, 0.02 inches, 0.01 inches, or 0.005 inches of the intended mating position. The end effector may then reposition the first component relative to the second component so that it is more precisely in the intended mating position. For example, the end effector may slide the first component while it is in contact with the second component until the first component contacts an adjacent component that had been previously mated to the second component. This additional positioning step may reduce the tolerance relative to the desired mating position to less than 0.02 inches, 0.01 inches, 0.005 inches, 0.002 inches, 0.001 inches, 0.0005 inches, 0.0002 inches, or 0.0001 inches.

In step 406, the first adhesive may be allowed to set once the first and the second component have been mated. In some embodiments, the first adhesive may set setting in less than five minutes after the first component and the second component 104 are placed in a mating position. The end effector may hold the first component in place while the first adhesive is allowed to cure. Any of the adhesives and arrangements described herein, including with respect to FIGS. 1-3, may be used.

In step 408, the end effector may be decoupled from the first component 102 after the first adhesive has set. For example, the vacuum cups or other engagement structures may release the first component. The end effector may then engage a new component, which it may then mate to the second component (or other component) repeating the mating process 400 with this new component. In some embodiments, the new component may be mated to the second component after the first adhesive has cured but before the second adhesive has been cured. The method 400 may be repeated any number of times in this manner. In some embodiments, two, three, four, five, or more components may be mated before the structural adhesive on the first component has cured.

In step 410, the second adhesive may be allowed to set. The second may require greater than 5 minutes to set. In some embodiments, the first adhesive may maintain the first component and the second component in the mating position while the second adhesive sets.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. A system for mating components, the system comprising:
a first component;
a second component;
a first adhesive; and
a second adhesive, the second adhesive being different than the first adhesive;
wherein:
the first adhesive is configured to set in less than 5 minutes after the first component and the second component are placed in the mating position; and
the second adhesive requiring greater than 5 minutes to set, the first adhesive, after setting, having sufficient strength to maintain the first component and the second component in the mating position while the second adhesive sets.

2. The system of claim 1, wherein the first component further comprises a first plurality of holes.

3. The system of claim 2, wherein:
the second component further comprises a second plurality of holes; and
the first plurality of holes and the second plurality of holes are arranged such that, when the first component and the second component are placed in a mating position relative to one-another, the first plurality of holes are aligned with the second plurality of holes.

4. The system of claim 3, wherein the first adhesive is positioned in the first plurality of holes.

5. The system of claim 1, wherein the first adhesive comprises:
a first compound; and
a second compound, the first adhesive being configured to set when the first compound contacts the second compound.

6. The system of claim 1, wherein a surface on which the first adhesive is applied is roughened by laser etching.

7. The system of claim 1, wherein the first component and the second component are selected from a group consisting of wing stringers, wing ribs, or panels.

8. The system of claim 1, wherein the first component comprises carbon fiber.

9. The system of claim 1, further comprising an end effector, the end effector being configured to place the first component and the second component in a mating position relative to one-another.

10. The system of claim 1, wherein the first adhesive is configured to set in less than 30 seconds after the first component and the second component are placed in the mating position.

11. A method for mating components, the method being performed using a system comprising a first component, a second component, a first adhesive, a second adhesive, and an end effector, the method comprising:
coupling the end effector to the first component;
positioning, using the end effector, the first component in a mating position relative to the second component, the first adhesive being applied to at least one of the first component and the second component, and the second adhesive being applied to at least one of the first component and the second component;
allowing the first adhesive to set, the first adhesive setting in less than 5 minutes after the first component and the second component are placed in the mating position;
decoupling the end effector from the first component;
allowing the second adhesive to set, the second adhesive requiring greater than 5 minutes to set, the first adhesive maintaining the first component and the second component in the mating position while the second adhesive sets.

12. The method of claim 11, wherein the first component further comprises a first plurality of holes.

13. The method of claim 12, wherein:
the second component further comprises a second plurality of holes; and
the first plurality of holes and the second plurality of holes are arranged such that, when the first component and the second component are placed in the mating position relative to one-another, the first plurality of holes are aligned with the second plurality of holes.

14. The method of claim 13, wherein the first adhesive is positioned in the first plurality of holes.

15. The method of claim 11, wherein the first adhesive comprises:
a first compound; and
a second compound, the first adhesive being configured to set when the first compound contacts the second compound.

16. The method of claim 15, wherein:
the first compound is positioned in the first plurality of holes; and
the second compound is positioned in the second plurality of holes.

17. The method of claim 11, wherein the first component and the second component are selected from a group consisting of wing stringers, wing ribs, or panels.

18. The method of claim 11, wherein the first component is composed of carbon fiber.

19. The method of claim 11, wherein the first adhesive is configured to set in less than 30 seconds after the first component and the second component are placed in the mating position

20. The method of claim 11, wherein a surface on which the first adhesive is applied is roughened by laser etching.
